(19) United States
(12) Patent Application Publication
(10) Pub. No.: US 2019/0305610 A1
(43) Pub. Date: Oct. 3, 2019

(54) WIRELESS POWER TRANSMISSION DEVICE AND WIRELESS POWER TRANSMISSION SYSTEM

(71) Applicant: TDK CORPORATION, Tokyo (JP)

(72) Inventor: Hisashi OYAMA, Tokyo (JP)

(73) Assignee: TDK CORPORATION, Tokyo (JP)

(21) Appl. No.: 16/298,054

(22) Filed: Mar. 11, 2019

(30) Foreign Application Priority Data
Mar. 29, 2018 (JP) 2018-065947

(51) Int. Cl. H02J 50/80; H02J 50/12; H04B 5/00; B60L 53/10; B60L 53/53

(52) U.S. Cl. CPC H02J 50/80; H02J 50/12; H02J 7/025; B60L 53/10; B60L 53/53; H04B 5/0037

(57) ABSTRACT

A wireless power transmission device, configured to transmit AC power to a power receiving coil of a wireless power reception, and that can curb an increase in production costs and curb destabilization of the power which is received by a wireless power reception device with a decrease in quality of wireless communication includes: power transmitting coil that is magnetically coupled to the power receiving coil; power transmitting circuit that is configured to supply an AC voltage to the power transmitting coil; transmission-side communication unit that is configured to perform wireless communication with the wireless power reception device; measuring unit that is configured to measure a characteristic value of the wireless communication; and control circuit that is configured to control the AC voltage which is supplied from the power transmitting circuit to the power transmitting coil on the basis of the characteristic value measured by the measuring unit.

### BACKGROUND OF THE INVENTION

### Field of the Invention

The present invention relates to a wireless power transmission device and a wireless power transmission system.

### Description of Related Art

Priority is claimed on Japanese Patent Application No. 2018-065947, filed Mar. 29, 2018, the content of which is incorporated herein by reference.

Technology associated with a wireless power transmission system that performs wireless power transmission between a wireless power transmission device including a power transmitting coil and a wireless power reception device including a power receiving coil has been studied and developed. Here, wireless power transmission refers to transmission of power in a wireless manner.

In such wireless power transmission, a method of transmitting information indicating the power received by the wireless power reception device to the wireless power transmission device and controlling the power which is transmitted from the wireless power transmission device to the wireless power reception device on the basis of the information is known as a method of stabilizing the power which is received by the wireless power reception device. The transmission of information from the wireless power reception device to the wireless power transmission device is often performed by wireless communication using Wi-Fi (registered trademark). Here, wireless communication using Wi-Fi (registered trademark) is used in various facilities such as commercial facilities and home facilities in addition to industrial facilities. Accordingly, the quality of wireless communication which is performed between the wireless power transmission, device and the wireless power reception device may decrease due to interference of radio waves or the like. When the quality decreases, the power which is received by the wireless power reception device is destabilized.

As a communication control system for curbing a decrease in the quality of wireless communication, a communication control system that controls communication which is performed between a plurality of communication stations connected to a communication path which is multiplexed from one main path and a plurality of sub-paths and includes communication function realizing means that are multiplexed to correspond to the main path and the sub-paths and realize a communication function in a predetermined layer of an OSI hierarchical model, a high-priority communication means that performs high-priority communication via the communication function realizing means corresponding to one of the multiplexed communication paths, and a low-priority communication means that performs low-priority communication via the communication function realizing means corresponding to the sub-paths and in which the high-priority communication means and the low-priority communication means are disposed in a single communication station is known (see Patent Document 1).

As a power transmission device for curbing a decrease in the quality of wireless communication, a power transmission device that includes a first antenna, a first communication means that performs communication with a power reception device using the first antenna, a power supply unit that generates power, a second antenna that transmits power generated by the power supply unit to the power reception device, a second communication means that performs communication with the power reception device using the second antenna, a measuring means that measures a first communication quality of the first communication means and a second communication quality of the second communication means, and a control means that transmits and receives transmission control information to and from the power reception device using the first communication means or the second communication and controls transmission of power to the power reception device on the basis of the transmission control information during transmission of power to the power reception device and in which the control means selects one of the first communication means and the second communication means on the basis of the first communication quality and the second communication quality and transmits the transmission control information is known (see Patent Document 2).

### PATENT DOCUMENTS

[Patent Document 1] Japanese Unexamined Patent Application, First Publication No. 2005-176161

[Patent Document 2] Japanese Unexamined Patent Application, First Publication No. 2014-050271

### SUMMARY OF THE INVENTION

Here, in the communication control system described in Patent Document 1, sub-paths are provided to curb a decrease in the quality of wireless communication as described above. Accordingly, the communication control system in which the sub-paths are provided may have a higher production cost than a communication control system in which such sub-paths are not provided.

On the other hand, in the power transmission device described in Patent Document 2, the second communication means is provided to curb a decrease in the quality of wireless communication as described above. Accordingly, the power transmission device in which the second communication means is provided may have a higher production cost than a power transmission device in which the second communication means is not provided.

The invention is made in consideration of the above-mentioned circumstances and an objective thereof is to provide a wireless power transmission device and a wireless power transmission system that can curb an increase in production costs and curb destabilization of the power which is received by a wireless power reception device with a decrease in, quality of wireless communication.

According to an aspect of the invention, there is provided a wireless power transmission device that is configured to transmit an AC power to a power receiving coil of a wireless power reception device. The wireless power transmission device includes: a power transmitting coil that is magnetically coupled to the power receiving coil; a power transmitting circuit that is configured to supply an AC voltage to the power transmitting coil; a transmission-side communication unit that is configured to perform wireless communication with the wireless power reception device; a measuring unit that is configured to measure a characteristic value of the wireless communication; and a control circuit that is configured to control the AC voltage which is supplied from the power transmitting circuit to the power transmitting coil on the basis of the characteristic value measured by the measuring unit.

According to the aspect of the invention, it is possible to curb an increase in production costs and curb destabilization of the power which is received by a wireless power reception device with a decrease in quality of wireless communication.

### BRIEF DESCRIPTION OF THE DRAWINGS

FIG. 1 is a diagram showing an example of a configuration of a wireless power transmission system 1 according to an embodiment;

FIG. 2 is a diagram showing an example of a flow of processes of causing a control circuit 14 to control an AC voltage which is supplied from a power transmitting circuit 12 to a power transmitting coil L1.

FIG. 3 is a diagram showing an example of a table in which a response speed and three gains in PID control are correlated with each other;

FIG. 4 is a diagram showing an example of a relationship between an elapsed time after a wireless power transmission device 10X according to the related art has started transmission of power to a wireless power reception device 20X according to the related art and the power which is received by the wireless power reception device 20X according to the related art; and

FIG. 5 is a diagram showing an example of a relationship between an elapsed time after a wireless power transmission device 10 has started transmission of power to a wireless power reception device 20 and the power which is received by the wireless power reception device 20.

### DETAILED DESCRIPTION OF THE INVENTION

### Embodiment

Hereinafter, an embodiment of the invention will be described with reference to the accompanying drawings. In this embodiment, transmission of power in a wireless manner s referred to as wireless power transmission for the purpose of convenience of description. In this embodiment, a conductor that transmits an electrical signal based on a DC power or an electrical signal based on an AC power is referred to as a transmission line. A transmission line is, for example, a conductor which is printed on a board. A transmission line may be a wire which is a conductor formed in a line shape or the like instead of a conductor.

Outline of Wireless Power Transmission System

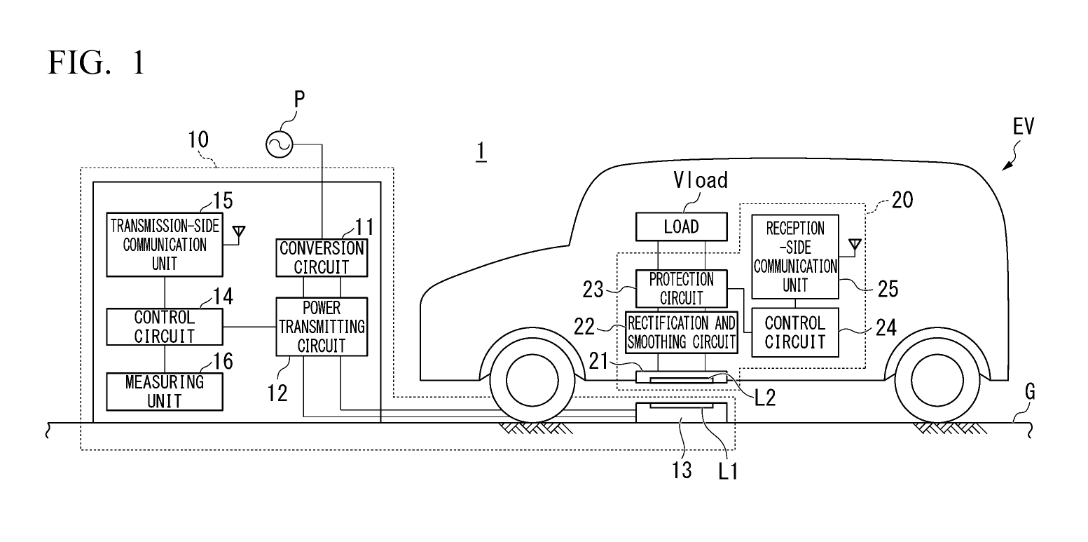

First, an outline of a wireless power transmission system 1 according to the embodiment will be described. FIG. 1 is a diagram showing an example of a configuration of a wireless power transmission system 1 according to the embodiment.

The wireless power transmission system 1 includes a wireless power transmission device 10 and a wireless power reception device 20.

In the wireless power transmission system 1, power is transmitted from the wireless power transmission device 10 to the wireless power reception device 20 by wireless power transmission. More specifically, in the wireless power transmission system 1, power is transmitted from a power transmitting coil L1 of the wireless power transmission device 10 to a power receiving coil L2 of the wireless power reception device 20 by wireless power transmission. The wireless power transmission system 1 performs wireless power transmission, for example, using a magnetic field resonance system. The wireless power transmission system 1 may be configured to perform wireless power transmission using another system instead of a magnetic field resonance system.

In the following description, it is assumed that the wireless power transmission system 1 is applied to a system that performs charging of a battery (a secondary battery) mounted in an electric vehicle EV using wireless power transmission as shown in FIG. 1. An electric vehicle EV is a motor-driven vehicle (a moving object) that travels by driving a motor using power charged into a battery. In the example shown in FIG. 1, the wireless power transmission system 1 includes the wireless power transmission device 10 which is installed on a ground surface G on a charging facility side and the wireless power reception device 20 which is mounted in an electric vehicle EV. The wireless power transmission system 1 may have a configuration in which it is applied to another device, another system, or the like instead of the configuration in which it is applied to the above-mentioned system.

In wireless power transmission using a magnetic field resonance system, the wireless power transmission system 1 causes resonance frequencies of a transmission-side resonance circuit (which is included in a power transmitting coil unit 13 which will be described later in the example shown in FIG. 1) which is not shown and which is included in the wireless power transmission device 10 and a reception-side resonance circuit (which is included in a power receiving coil unit 21 which will be described later in the example shown in FIG. 1) which is not shown and which is included in the wireless power reception device 20 to approach each other (or cause the resonance frequencies to match each other), applies high-frequency current and voltage in the vicinity of the resonance frequency to a power transmitting coil unit 13, and wirelessly transmits (supplies) power to a power receiving coil unit 21 which is electromagnetically resonated with the power transmitting coil unit 13.

Accordingly, the wireless power transmission system 1 according to this embodiment can transmit power supplied from a charging facility side to an electric vehicle EV in a wireless manner and charge a battery mounted in the electric vehicle EV using wireless power transmission without connection using a charging cable.

The wireless power transmission system 1 will be described below by comparing the wireless power transmission system 1 with a wireless power transmission system 1X other than the wireless power transmission system 1. The wireless power transmission system 1X is, for example, a wireless power transmission system according to the related art. The wireless power transmission system 1X includes a wireless power transmission device 10X and a wireless power reception device 20X. The wireless power transmission device 10X is, for example a wireless power transmission device according to the related art. The wireless power reception device 20X is, for example, a wireless power reception device 20 according to the related art.

In the wireless power transmission system 1X, as a method of stabilizing the power which is received by the wireless power reception device 20X, a method of transmitting information indicating the power which is received by the wireless power reception device 20X to the wireless power transmission device 10X and controlling the power which is transmitted from the wireless power transmission device 10X to the wireless power reception device 20X on the basis of the information is known. Such transmission of information from the wireless power reception device 20X to the wireless power transmission device 10X is often performed using wireless communication using Wi-Fi (registered trademark). The wireless communication using Wi-Fi (registered trademark) is used in various facilities such as commercial facilities and home facilities in addition to industrial facilities. Accordingly, the quality of wireless communication which is performed between the wireless power transmission device 10X and the wireless power reception device 20X may decrease due to interference of radio waves or the like. When the quality decreases, the power which is received by the wireless, power reception device 20X is destabilized.

In order to curb a decrease in quality of wireless communication, for example, a circuit or a device that realizes a communication means other than a communication means which is mainly used may be provided in the wireless power transmission system 1X. However, the production costs of the wireless power transmission system 1X in which the circuit or the device s provided may be higher than that of the wireless power transmission system 1X in which the circuit or the device is not provided.

In comparison with the wireless power transmission system 1X, the wireless power transmission device 10 in the wireless power transmission system 1 includes a power transmitting coil L1 that is magnetically coupled to a power receiving coil L2, a power transmitting circuit that supplies an AC voltage to the power transmitting coil L1, a transmission-side communication unit that performs wireless communication with the wireless power reception device 20, a measuring unit that measures a characteristic value of the wireless communication, and a control circuit that controls the AC voltage which is supplied from the power transmitting circuit to the power transmitting coil L1 on the basis of the characteristic value measured by the measuring unit. Accordingly, the wireless power transmission system 1 and the wireless power transmission device 10 can curb an increase in production costs and curb destabilization of the power which is received by the wireless power reception device 20 with a decrease in quality of wireless communication. The configuration of the wireless power transmission system 1 and the wireless power transmission device 10 will be described below in detail. In the following description, wireless communication which is performed between the wireless power transmission device 10 and the wireless power reception device 20 in the wireless power transmission system 1 is simply referred to as wireless communication for the purpose of convenience of description.

<Configuration of Wireless Power Transmission System>

The configuration of the wireless power transmission system 1 will be described below with reference to FIG. 1.

The wireless power transmission device 10 includes a conversion circuit 11, a power transmitting circuit 12, a power transmitting oil unit 13, a control circuit 14, a transmission-side communication unit 15, and a measuring unit 16. On the other hand, the wireless power reception device 20 includes a power receiving coil unit 21, a rectification and smoothing circuit 22, a protection circuit 23, a control circuit 24, and a reception-side communication unit 25. The wireless power reception device 20 can be connected to a load Vload. In the example shown in FIG. 1, the wireless power reception device 20 is connected to the load Vload. The wireless power reception device 20 may include the load Vload.

The conversion circuit 11 is, for example, an alternating current (AC)/direct current (DC) converter that is connected to an external commercial power supply P and converts an AC voltage input from the commercial power supply P into a desired DC voltage. The conversion circuit 11 is connected to the power transmitting circuit 12. The conversion circuit 11 supplies the DC voltage into which the AC voltage is converted to the power transmitting circuit 12.

The conversion circuit 11 is not particularly limited as long as it can output a DC voltage to the power transmitting circuit 12. For example, the conversion circuit 11 may be a conversion circuit in which a rectification and smoothing circuit that rectifies an AC voltage and converts the AC voltage into a DC voltage and a power factor correction (PFC) circuit that performs power factor correction are combined, may be a conversion circuit in which a rectification and smoothing circuit and a switching circuit such as a switch converter are combined, or may be another conversion circuit that outputs a DC voltage to the power transmitting circuit 12.

The power transmitting circuit 12 serves to convert a DC voltage supplied from the conversion circuit 11 into an AC voltage. For example, the power transmitting circuit 12 includes an inverter including a switching circuit in which a plurality of switching elements are bridge-connected. The power transmitting circuit 12 is connected to the power transmitting coil unit 13. The power transmitting circuit 12 supplies an AC voltage, a drive frequency of which has been controlled on the basis of a resonance frequency of a transmission-side resonance circuit of the power transmitting coil unit 13, to the power transmitting coil unit 13.

The power transmitting coil unit 13 includes, for example, an LC resonance circuit including a capacitor which is not shown in FIG. 1 along with the power transmitting coil L1 as a transmission-side resonance circuit. In this case, the power transmitting coil unit 13 can adjust the resonance frequency of the transmission-side resonance circuit by adjusting a capacitance of the capacitor. The wireless power transmission device 10 causes the resonance frequency of the transmission-side resonance circuit to approach (or match) a resonance frequency of a reception-side resonance circuit of the power receiving coil unit 21 and performs wireless power transmission using a magnetic field resonance system. The capacitor may include, for example, a capacitor connected in series to the power transmitting coil L1, may include a capacitor connected in series to the power transmitting coil L1 and a capacitor connected in parallel to the power transmitting coil L1, or may be constituted in another aspect. In the following description, it is assumed that the capacitor is a capacitor connected in series to the power transmitting coil L1. The power transmitting coil unit 13 may include another resonance circuit including the power transmitting coil L1 as the transmission-side resonance circuit instead of the LC resonance circuit. The power transmitting coil unit 13 may include another circuit or another circuit element in addition to the transmission-side resonance circuit. The power transmitting coil unit 13 may include a magnetic material that enhances magnetic coupling between the power transmitting coil L1 and the power receiving coil L2 or an electromagnetic shield that curbs leakage of a magnetic field generated by the power transmitting coil L1 to the outside.

The power transmitting coil L1 is, for example, a coil for wireless power transmission which is obtained by winding a Litz wire formed of copper or aluminum in a spiral shape. The power transmitting oil L1 in this embodiment is installed on the ground surface G or is buried in the ground surface (i such that it faces the bottom of the floor of the electric vehicle EV. In the following description, for example, it is assumed that the power transmitting coil L1 (that is, the power transmitting coil unit 13) is installed on the ground surface G along with the power transmitting circuit 12.

The control circuit 14 controls the wireless power transmission device 10. The control circuit 14 controls the transmission-side communication unit 15 such that a variety of information is transmitted and received to and from the wireless power reception device 20. For example, the control circuit 14 receives power information indicating the power received by the wireless power reception device 20 from the wireless power reception device 20 via the transmission-side communication unit 15.

The control circuit 14 acquires a characteristic value measured by the measuring unit 16 which will be described later from the measuring unit 16. The characteristic value is a characteristic value of wireless communication. More specifically, the characteristic value of wireless communication is a value indicating the quality of wireless communication and is a value which varies depending on an external communication status. Here, the external communication status includes a communication status of wireless communication which is performed between a device, other than the wireless power transmission device 10 and the wireless power reception device 20, a communication status of wireless communication which is performed between a device other than the wireless power reception device 20 and the wireless power transmission device 10, and a communication status of wireless communication which is performed between a plurality of devices other than both of the wireless power transmission device 10 and the wireless power reception device 20. In this embodiment, the characteristic value of wireless communication does not include an influence of transmission of power. Accordingly, the characteristic value of wireless communication in this embodiment is, for example, a response speed of wireless communication. The characteristic value of wireless communication may be another value indicating the quality of wireless communication such as a traffic volume of wireless communication instead of the response speed.

The control circuit 14 controls an AC voltage which is supplied from the power transmitting circuit 12 to the power transmitting coil L1 on the basis of the characteristic value acquired from the measuring unit 16 and the power information received from the wireless power reception device 20 via the transmission-side communication unit 15. Specifically, the control circuit 14 calculates an amount of power transmitted to the wireless power reception device 20 on the basis of the power information. The control, circuit 14 controls a drive frequency of an inverter included in the power transmitting circuit 12, a duty ratio of the inverter, or the like on the basis of the calculated amount of transmitted power and the characteristic value. Accordingly, the control circuit 14 controls the AC voltage which is supplied from the power transmitting circuit 12 to the power transmitting coil L1. That the control circuit 14 adjusts the AC voltage which is supplied from the power transmitting circuit 12 to the power transmitting coil L1 by feedback control based on the power information. For example, the control circuit 14 performs PID control as feedback control for adjusting the AC voltage. The control circuit 14 may perform control other than PID control as feedback control for adjusting the AC voltage.

The transmission side communication unit 15 is, for example, a communication circuit (or a communication device) that performs wireless communication based on a communication protocol such as Wi-Fi (registered trademark). The transmission-side communication unit 15 transmits and receives a variety of information to and from the wireless power reception device 20 in accordance with a signal from the control circuit 14.

The measuring unit 16 is a sensor (or a measuring device) that measures a characteristic value indicating the quality of wireless communication which is performed by the transmission-side communication unit 15. In this example, the measuring unit 16 measures a response speed of wireless communication as the characteristic value. The measuring unit 16 outputs the measured response speed to the control circuit 14.

The power receiving coil unit 21 includes, for example, an LC resonance circuit including a capacitor which is not shown in FIG. 1 along with the power receiving coil L2 as a reception-side resonance circuit. In this case, the power receiving coil unit 21 can adjust the resonance frequency of the reception-side resonance circuit by adjusting capacitance of the capacitor. The wireless power reception device 20 performs wireless power transmission using a magnetic field resonance system by causing the resonance frequency of the reception-side resonance circuit to approach (or match) the resonance frequency of the transmission-side resonance circuit. The capacitor may include, for example, a capacitor connected in series to the power receiving coil L2, may include a capacitor connected in series to the power receiving coil L2 and a capacitor connected in, parallel to the power receiving coil L2, or may be constituted in another aspect. In the following description, it is assumed that the capacitor is a capacitor connected in series to the power receiving coil L2. The power receiving coil unit 21 may include another resonance circuit including the power receiving coil L2 as the reception-side resonance circuit instead of the LC resonance circuit. The power receiving coil unit 21 may include another circuit or another circuit element in addition to the reception-side resonance circuit. The power receiving coil unit 21 may include a magnetic material that enhances magnetic coupling between the power transmitting coil L1 and the power receiving coil L2 or an electromagnetic shield that curbs leakage of a magnetic field generated by the power receiving coil L2 to the outside.

The rectification and smoothing circuit 22 is connected to the power receiving coil unit 21, and rectifies an AC voltage supplied from the power receiving coil L2 and converts the AC voltage into a DC voltage. The power receiving coil L2 can be connected to a load Vload. In the example shown in FIG. 1, the rectification and smoothing circuit 22 is connected to the load Vload via the protection circuit 23. When the rectification and smoothing circuit 22 is connected to the load Vload, the rectification and smoothing circuit 22 supplies the converted DC power to the load Vload. In the wireless power reception device 20, when the rectification and smoothing circuit 22 is connected to the load Vload, the rectification and smoothing circuit 22 may be connected to the load Vload via a charging circuit instead of the protection circuit 23 or may be connected to the load Vload via the charging circuit in addition to the protection circuit 23.

When the load Vload is connected to the rectification and smoothing circuit 22, the load Vload is supplied with a DC voltage from the rectification and smoothing circuit 22. For example, the load Vload is a battery mounted in the electric vehicle EV or a motor mounted in the electric vehicle EV. The load Vload is a resistive load of which an equivalent resistance value varies over time depending on demand conditions (storage conditions or consumption conditions) of power. In the wireless power reception device 20, the load Vload may be another load which is supplied with a DC voltage supplied from the rectification and smoothing circuit 22 instead of the battery or the motor.

When the state of the wireless power reception device 20 becomes a state (for example, an overvoltage state) in which there is a likelihood that a voltage or a current with an unintentional magnitude will be supplied to the load Vload, the protection circuit 23 prevents a failure from occurring due to supply of the voltage or the current to the load Vload and protects the load Vload. For example, the protection circuit 23 includes a switching element that short-circuits terminals of the power receiving coil L2. The protection circuit 23 switches the state of the switching element between ON and OFF in accordance with a drive signal from the control circuit 24. The wireless power reception device 20 may not include the protection circuit 23.

The control circuit 24 controls the wireless power reception device 20. The control circuit 24 controls the reception-side communication unit 25 such that a variety of information is transmitted and received to and from the wireless power transmission device 10. For example, the control circuit 24 transmits the power information to the wireless power transmission device 10 via the reception-side communication unit 25.

When the state of the wireless power reception device 20 becomes a state in which there is a likelihood that a voltage or a current with an unintentional magnitude will be supplied to the load Vload, the control circuit 24 outputs a drive signal to the protection circuit 23 to protect the load Vload.

The reception-side communication unit 25 is, for example, a communication circuit (or a communication device) that performs wireless communication based on a communication protocol such as Wi-Fi (registered trademark). The reception-side communication unit 25 transmits and receives a variety of information to and from the wireless power transmission device 10 in accordance with a signal from the control circuit 24.

<Process of Causing Control Circuit to Control AC Voltage Supplied from Power Transmitting Circuit to Power Transmitting Coil>

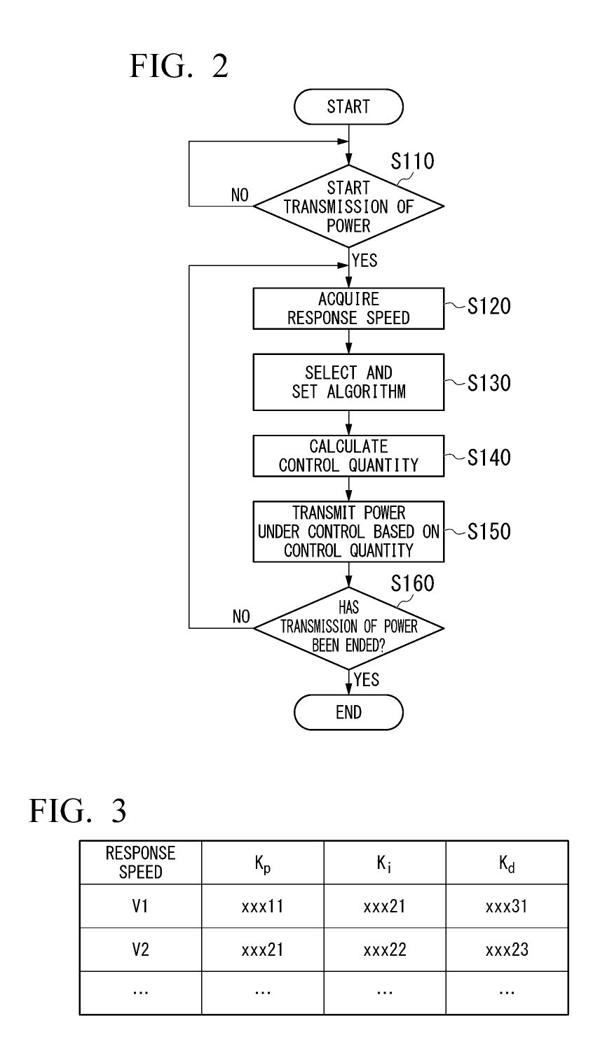

A process of causing the control circuit 14 to control an AC voltage which is supplied from the power transmitting circuit 12 to the power transmitting coil L1 will be described below with reference to FIG. 2. FIG. 2 is a diagram showing an example of a flow of a process of causing the control circuit 14 to control an AC voltage which is supplied from the power transmitting circuit 12 to the power transmitting coil L1.

The control circuit 14 determines whether transmission of power from the wireless power transmission device 10 to the wireless power reception device 20 is to be started (Step S110). For example, when information for requesting the wireless power transmission device 10 to start transmission of power is received from the wireless power reception device 20 via the transmission-side communication unit 15, the control circuit 14 determines that transmission of power from the wireless power transmission device 10 to the wireless power reception device 20 is to be started. On the other hand, when information for requesting the wireless power transmission device 10 to start transmission of power is not received from the wireless power reception device 20 via the transmission-side communication unit 15, the control circuit 14 determines that transmission of power from the wireless power transmission device 10 to the wireless power reception device 20 is not to be started.

When it is determined that transmission of power from the wireless power transmission device 10 to the wireless power reception device 20 is not to be started (NO in Step S110), the control circuit 14 determines whether transmission of power from the wireless power transmission device 10 to the wireless power reception device 20 is to be started in Step S110 again. On the other hand, when it is determined that transmission of power from the wireless power transmission device 10 to the wireless power reception device 20 is to be started (YES in Step S110), the control circuit 14 controls the power transmitting circuit 12 such that supply of an AC voltage to the power transmitting coil unit 13 is started by the power transmitting circuit 12. Accordingly, the wireless power transmission device 10 starts transmission of power from the wireless power transmission, device 10 to the wireless power reception device 20.

Here, after transmission of power from the wireless power transmission device 10 to the wireless power reception device 20 has been started, the control circuit 14 periodically transmits transmission request information which is information for requesting the wireless power reception device 20 to transmit the power information to the wireless power reception device 20 whenever a predetermined time elapses. Whenever the transmission request information is received, the wireless power reception device 20 transmits power information to the wireless power transmission device 10 as a response to the received transmission request information. Then, the control circuit 14 receives power information transmitted from the wireless power reception device 20 via the transmission-side communication unit 15.

After transmission of power from the wireless power transmission device 10 to the wireless power reception device 20 has been started, the control circuit 14 acquires a response speed measured by the measuring unit 16 from the measuring unit 16 (Step S120). Here, the response speed is expressed by a time from a time point at which the control circuit 14 has transmitted the transmission request information to the wireless power reception device 20 via the transmission-side communication unit 15 to a time point at which the control circuit 14 has received power information as a response thereto via the transmission-side communication unit 15 in this example. Accordingly, when a delay occurs in wireless communication, the response speed is lower (that is, longer) than a response speed measured by the measuring unit 16 when a delay does not occur in wireless communication. The response speed measured by the measuring unit 16 when a delay occurs in wireless communication may be expressed by another value corresponding to the time from a time point at which the control circuit 14 has transmitted the transmission request information to the wireless power reception device 20 via the transmission-side communication unit 15 to a time point at which the control circuit 14 has received power information as a response thereto via the transmission-side communication unit 15.

When a response speed is acquired from the measuring unit 16, the control circuit 14 selects an algorithm, which is correlated with a response speed closest to the response speed acquired from the measuring unit 16 among a plurality of different algorithms stored in advance in, a memory which is not shown, as an algorithm which is used for feedback control of the power transmitting circuit 12. That is, the plurality of different algorithms stored in advance in the memory area plurality of different algorithms which are used by the control circuit 14 for feedback control of the power transmitting circuit 12. The control circuit 14 sets the selected algorithm as an algorithm which is used for feedback control, of the power transmitting circuit 12 (Step S130). The process of Step S130 will be described below.

In this embodiment, when it is mentioned that the plurality of algorithms stored in advance in the memory are different from each other, it means that the plurality of algorithms are different from each other in at least one of an execution sequence associated with feedback control which is performed by the algorithms, an equation which is used for the feedback control, a constant which is included in the equation, and types of parameters which are included in the equation. In the following description, for example, it is assumed that the feedback control of the power transmitting circuit 12 which is performed by the control circuit 14 is PID control. In the following description, for example it is assumed that the plurality of algorithms stored in advance in the memory are different from each other in only a constant which is included in an equation used for PID control, that is, in only a gain in the PID control.

The equation which is used for PID control is, for example, Equation (1) which will be described below.

$$u = {K}_{p} ( {P}_{det} - {P}_{tgt} ) + {K}_{i} Σ ( {P}_{det} - {P}_{tgt} ) Δ t + {K}_{d} Σ \frac{{P}_{det} - {P}_{tgt}}{Δ t} \qquad ( 1 )$$

In Equation (1), u denotes a control quantity which is controlled in the PID control performed by the control circuit 14 and examples thereof include a drive frequency of an inverter which is included in the power transmitting circuit 12 and a duty ratio of the inverter. In Equation (1), Kₚ, Kᵢ, and K_{d} denote three types of gains in the PID control. In Equation (1), Δt denotes a response time which is measured by the measuring unit 16. In Equation (1), P_{det} denotes the power which is indicated by power information acquired by the control circuit 14. In Equation (1), P_{tgt} denotes a target power which is to be received by the wireless power reception device 20.

In this example, as described above, the plurality of algorithms stored in advance in the memory which is not shown are different from each other in only the constants which are included in the equation used in the PID control, that is, in only the gains in the PID control. Accordingly, in Step S130, the control circuit 14 selects an algorithm correlated with a response speed closest to the response speed acquired from the measuring unit 16 among the plurality of algorithms stored in advance in the memory which is not shown as an, algorithm which is used for PID control of the power transmitting circuit 12, for example, by selecting a gain correlated with the response speed closest to the response speed acquired from the measuring unit 16 among gains in the PID control which are a plurality of different gains stored in advance in the memory which is not shown.

For example, in the memory which is not shown, gains correlated with a plurality of response speeds are stored in the table shown in FIG. 3. FIG. 3 is a diagram showing an example of a table in which response speeds and three gains in PID control are correlated. As shown in FIG. 3, the response speeds and three gains Kₚ, Kᵢ, and K_{d} in the PID control are correlated with each other in the table. The three gains correlated with the response speeds may be determined by simulation or the like such that the control quantity u is kept constant or may be determined by analysis calculation such that the control quantity u is kept constant.

After the process of Step S130 has been performed, the control circuit 14 calculates the control quantity in Equation (1), that is, u, on the basis of the algorithm set in Step S130 and the power indicated by the latest power information acquired from the wireless power reception device 20 (Step S140).

Then, the control circuit 14 controls the power transmitting circuit 12 on the basis of the control quantity calculated in Step S140 and transmits power corresponding to the control quantity to the wireless; power reception device 20 (Step S150).

Then, the control circuit 14 determines whether transmission of power from the wireless power transmission device 10 to the wireless power reception device 20 is to be ended (Step S160). For example, when information for requesting the wireless power transmission device 10 to end transmission of power is received from the wireless power reception device 20 via the transmission-side communication unit 15, the control circuit 14 determines that transmission of power from the wireless power transmission device 10 to the wireless power reception device 20 is to be ended. On the other hand, when information for requesting the wireless power transmission device 10 to end transmission of power is not received from the wireless power reception device 20 via the transmission-side communication unit 15, the control circuit 14 determines that transmission of power from the wireless power transmission device 10 to the wireless power reception device 20 is not to be ended.

When it is determined that transmission of power from the wireless power transmission device 10 to the wireless power reception device 20 is not to be ended (NO in Step S160), the control circuit 14 acquires a response speed measured by the measuring unit 16 from the measuring unit 16 again in Step S120. On the other hand, when it is determined that transmission of power from the wireless power transmission device 10 to the wireless power reception device 20 is to be ended (YES in Step S120), the control circuit 14 ends the flow of processes.

In this way, in the wireless power reception device 20, the control circuit 14 controls an AC voltage which is supplied from the power transmitting circuit 12 to the power transmitting coil L1 on the basis of the characteristic value measured by the measuring unit 16. Accordingly, the wireless power reception device 20 can curb an increase in production costs and curb destabilization of the power which is received by the wireless power reception device 20 with a decrease in quality of wireless communication.

In the above-mentioned wireless power transmission system 1, the transmission-side communication unit 15 and the reception-side communication unit 25 perform wireless communication using Wi-Fi (registered trademark). Since there is a function for collision avoidance between communication details in the wireless communication using Wi-Fi (registered trademark), it cannot be said that the response speed increases or decreases with an increase or decrease in traffic volume. Accordingly, in this configuration, it is preferable that the characteristic value of wireless communication be a response speed of wireless communication. On the other hand for example, in a configuration in which the transmission-side communication unit 15 and the reception-side communication unit 25 perform wireless communication using Bluetooth (registered trademark), it is preferable that the characteristic value of wireless communication which has been described above be a traffic volume of wireless communication. This is because there is no function for collision avoidance between communication details in the wireless communication using Bluetooth (registered trademark) and a loss of data due to collision between communication details may occur with an increase in traffic volume.

The characteristic value of wireless communication which has been described above may include both the response speed of wireless communication and the traffic volume of wireless communication. In this case, the control circuit 14 controls an AC voltage which is supplied from the power transmitting circuit 12 to the power transmitting coil L1 on the basis of both the response speed and the traffic volume measured by the measuring unit 16.

The above-mentioned control circuit 14 may be configured to perform feedback control of the conversion circuit 11 through the process flow in the flowchart shown in FIG. 3 instead of feedback control of the power transmitting circuit 12 through the process flow. In this case, u in Equation (1) is, for example, a DC voltage which is output from the conversion circuit 11.

<Advantages of Feedback Control of Power Transmitting Circuit by Control Circuit>

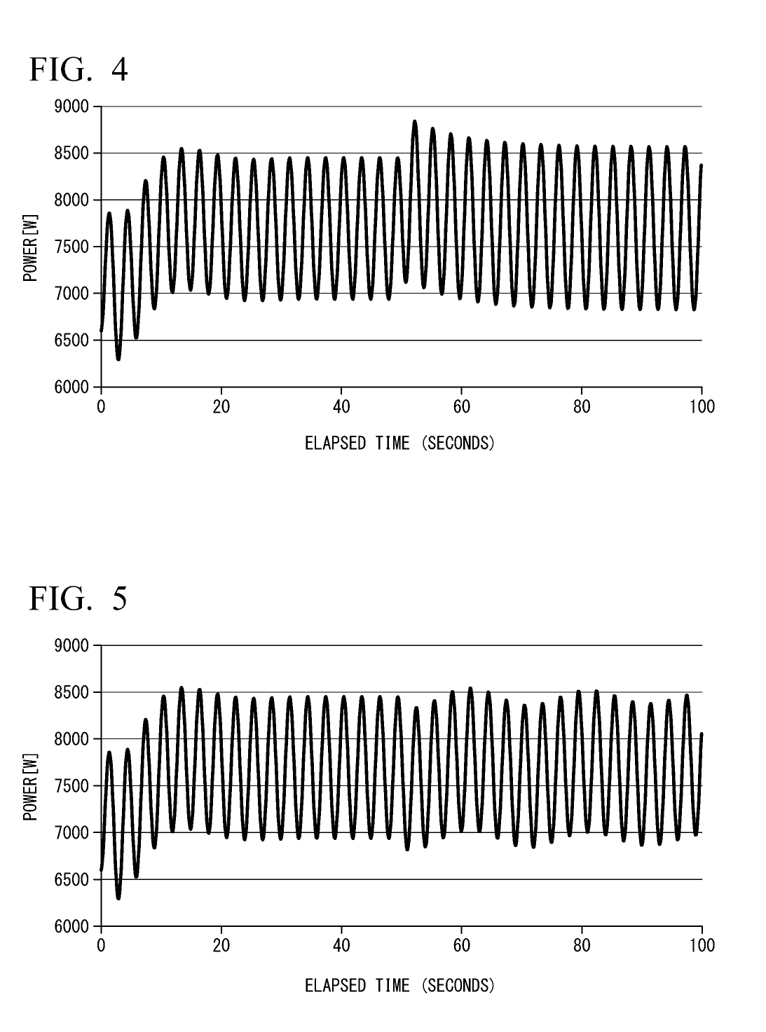

Advantages of feedback control of the power transmitting circuit 12 by the control circuit 14 will be described below with reference to FI GS. 4 and 5. FIG. 4 is a diagram showing an example of a relationship between an elapsed time after a wireless power transmission device 10X according to the related art has started transmission of power to a wireless power reception device 20X according to the related art and the power which is received by the wireless power reception device 20X according to the related art. FIG. 4 is a diagram showing an example of the relationship when a delay of wireless communication occurs in 50 seconds after the transmission of power has been started. In this case, as shown in FIG. 4, a median value of a fluctuation width of the power which is received from the wireless power transmission device 10X by the wireless power reception device 20X is greater than a median value of a fluctuation width of the power which is received from the wireless power transmission device 10X by the wireless power reception device 20X at a time before the delay of wireless communication has occurred with occurrence of the delay of wireless communication. This means that when a delay of wireless communication occurs in the wireless power transmission system 1X, the power which is received by the wireless power reception device 20X is destabilized with a decrease in the quality of wireless communication.

FIG. 5 is a diagram showing an example of a relationship between an elapsed time after the wireless power transmission device 10 has started transmission of power to the wireless power reception device 20 and the power which is received by the wireless power reception device 20. FIG. 5 is a diagram showing an example of the relationship when a delay of wireless communication occurs in 50 seconds after the transmission of power has been started. In this case, as shown in FIG. 5, a median value of a fluctuation width of the power which is received from the wireless power transmission device 10 by the wireless power reception device 20 is almost equal to a median value of a fluctuation width of the power which is received from the wireless power transmission device 10 by the wireless power reception device 20 at a time before the delay of wireless communication has occurred with occurrence of the delay of wireless communication. This means that when a delay of wireless communication occurs in the wireless power transmission system 1, destabilization of the power which is received by the wireless power reception device 20 with a decrease in the quality of wireless communication is curbed.

That is, the wireless power transmission system 1 and the wireless power transmission device 10 can curb an increase in production costs which is caused by providing an additional circuit, device, and the like and curb destabilization of the power which is received by the wireless power reception device 20 with a decrease in the quality of wireless communication.

As described above, a wireless power transmission device according to the embodiment (the wireless power transmission device 10 in this example) transmits an AC power to a power receiving coil (the power receiving coil L2 in this example) of a wireless power reception device (the wireless power reception device 20 in this example). The wireless power transmission device includes a power transmitting coil (the power transmitting coil L1 in this example) that is magnetically coupled to the power receiving coil, a power transmitting circuit (the power transmitting circuit 1 in this example) that supplies an AC voltage to the power transmitting coil, a transmission-side communication unit (the transmission-side communication unit 15 in this example) that performs wireless communication with the wireless power reception device, a measuring unit (the measuring unit 16 in this example) that measures a characteristic value of wireless communication (at least one of the response speed of wireless communication and the traffic volume of wireless communication in this example), and a control circuit (the control circuit 14 in this example) that controls the AC voltage which is supplied from the power transmitting circuit to the power transmitting coil on the basis of the characteristic value measured by the measuring unit. Accordingly, it is possible to curb an increase in production costs and curb destabilization of the power which is received by the wireless power reception device with a decrease in quality of wireless communication.

In the wireless power transmission device, the characteristic value may be a response speed of the wireless communication. Accordingly, the wireless power transmission device can curb destabilization of the power which is received by the wireless power reception device with a decrease in quality of wireless communication on the basis of the response speed of the wireless communication.

In the wireless power transmission device, the control circuit may control the power transmitting circuit by feedback control using one algorithm which is correlated with the response speed measured by the measuring unit among a plurality of different algorithms which are used for feedback control of the power transmitting circuit. Accordingly, the wireless power transmission device can curb destabilization of the Power which is received by the wireless power reception device with a decrease in the quality of wireless communication by feedback control using an algorithm correlated with the response speed of the wireless communication.

In the wireless power transmission device, the feedback control may be PID control, and the plurality of different algorithms may have different gains of the PID control. Accordingly, the wireless power transmission device can curb destabilization of the power which is received by the wireless power reception device with a decrease in, the quality of wireless communication by PID control using an algorithm correlated with the response speed of the wireless communication.

In the wireless power transmission device, the characteristic value may be a traffic volume of the wireless communication. Accordingly, the wireless power transmission device can curb destabilization of the power which is received by the wireless power reception device with a decrease in the quality of wireless communication on the basis of the traffic volume of the wireless communication.

In the wireless power transmission device, the control circuit may control the power transmitting circuit by feedback control using one algorithm which is correlated with the traffic volume measured by the measuring unit among a plurality of different algorithms which are used for feedback control of the power transmitting circuit. Accordingly, the wireless power transmission device can curb destabilization of the power which is received by the wireless power reception device with a decrease in the quality of wireless communication by feedback control using an algorithm correlated with the traffic volume of the wireless communication.

In the wireless power transmission device, the feedback control may be PID control, and the plurality of different algorithms may be different from each other in a gain of the PID control. Accordingly, the wireless power transmission device can curb destabilization of the power which is received by the wireless power reception device with a decrease in the quality of wireless communication, by PID control using an algorithm correlated with the traffic volume of the wireless communication.

While an embodiment of the invention has been described above in detail with reference to the drawings, a specific configuration is not limited to the embodiment and can be subjected to change, substitution, deletion, and the like without departing from the gist of the invention.

A program for realizing a function of an arbitrary constituent unit of the above-mentioned device (for example, the wireless power transmission device 10 and the wireless power reception device 20) may be recorded on a computer-readable recording medium and, may be read and executed by a computer system. The “computer system” mentioned herein may include an operating system (OS) or hardware such as peripherals. Examples of the “computer-readable recording medium” include a portable medium such as a flexible disk, a magneto-optical disk, a read only memory (ROM), or a compact disk (CD)-ROM, and a storage device such as a hard disk built in a computer system. A recording medium, may be, for example, a recording medium that temporarily stores data. The “computer-readable recording medium” may include a medium that holds a program for a predetermined time like a volatile memory (for example, a random access memory (RAM)) in a computer system serving as a server or a client when a program is transmitted via a network such as the Internet or a communication line such as a telephone line.

The program may be transmitted from a computer system storing the program in a storage device or the like to another computer system via a transmission medium or carrier waves in the transmission medium. Here, the “transmission medium” for transmitting the program means a medium having a function of transmitting information like a network (a communication network) such as the Internet or a communication, circuit (a communication line) such as a telephone circuit.

The program may be designed to realize some of the above-mentioned functions. The program may be a so-called differential file (a differential program) which can realize the above-mentioned functions in combination with a program which has already been recorded in a computer system.

### EXPLANATION OF REFERENCES

1, 1X Wireless power transmission system
10, 10X Wireless power transmission device
11 Conversion circuit
12 Power transmitting circuit
13 Power transmitting coil unit
14 Control circuit
15 Transmission-side communication unit
16 Measuring unit
20, 20X Wireless power reception device
21 Power receiving coil unit
22 Rectification and smoothing circuit
23 Protection circuit
24 Control circuit
25 Reception-side communication unit
EC Electric vehicle
G Ground surface
L1 Power transmitting coil
L2 Power receiving coil
P Commercial power supply
Vload Load

What is claimed is:

1. A wireless power transmission device that is configured to transmit an AC power to a power receiving coil of a wireless power reception device, the wireless power transmission device comprising:
a power transmitting coil that is magnetically coupled to the power receiving coil;
a power transmitting circuit that is configured to supply an AC voltage to the power transmitting coil;
a transmission-side communication unit that is configured to perform wireless communication with the wireless power reception device;
a measuring unit that is configured to measure a characteristic value of the wireless communication; and
a control circuit that is configured to control the AC voltage which is supplied from the power transmitting circuit to the power transmitting coil on the basis of the characteristic value measured by the measuring unit.

2. The wireless power transmission device according to claim 1, wherein the characteristic value is a response speed of the wireless communication.

3. The wireless power transmission device according to claim 2, wherein the control circuit controls the power transmitting circuit by feedback control using one algorithm which is correlated with the response speed measured by the measuring unit among a plurality of different algorithms which are used for feedback control of the power transmitting circuit.

4. The wireless power transmission device according to claim 3, wherein the feedback control is PID control, and
wherein the plurality of different algorithms are different from each other in a gain of the PID control.

5. The wireless power transmission device according to claim 1, wherein the characteristic value is a traffic volume of the wireless communication.

6. The wireless power transmission device according to claim 5, wherein the control circuit controls the power transmitting, circuit by feedback control using one algorithm which is correlated with the traffic volume measured by the measuring unit among a plurality of different algorithms which are used for feedback control of the power transmitting circuit.

7. The wireless power transmission device according to claim 6, wherein the feedback control is PID control, and
wherein the plurality of different algorithms are different from each other in a gain of the PID control.

8. A wireless power transmission system comprising:
the wireless power transmission device according to claim 1; and
the wireless power reception device.

9. A wireless power transmission system comprising:
the wireless power transmission device according to claim 2; and
the wireless power reception device.

10. A wireless power transmission system comprising:
the wireless power transmission device according to claim 3; and
the wireless power reception device.

11. A wireless power transmission system comprising:
the wireless power transmission device according to claim 4; and
the wireless power reception device.

12. A wireless power transmission system comprising:
the wireless power transmission device according to claim 5; and
the wireless power reception device.

13. A wireless power transmission system comprising:
the wireless power transmission device according to claim 6; and
the wireless power reception, device.

14. A wireless power transmission system comprising:
the wireless power transmission device according to claim 7; and
the wireless power reception device.
